(19) United States
(12) Patent Application Publication
(10) Pub. No.: US 2021/0287843 A1
(43) Pub. Date: Sep. 16, 2021

(54) COIL ASSEMBLY, CIRCUIT ASSEMBLY, AND ELECTRICAL JUNCTION BOX

(71) Applicant: Sumitomo Wiring Systems, Ltd., Yokkaichi, Mie (JP)

(72) Inventor: Junya Aichi, Yokkaichi, Mie (JP)

(21) Appl. No.: 16/326,416

(22) PCT Filed: Aug. 18, 2017
(86) PCT No.: PCT/JP2017/029599

§ 371 Date: Feb. 19, 2019

(30) Foreign Application Priority Data
Aug. 22, 2016 (JP) 2016-162042

(51) Int. Cl. H01F 27/28; H02G 3/16; H01F 17/04; H01F 27/30

(52) U.S. Cl. CPC H01F 27/2828; H02G 3/16; H01F 2017/046; H01F 27/306; H01F 17/045

(57) ABSTRACT

A coil assembly including a magnetic core; and a coil including a winding portion formed by winding a flat wire edgewise, wherein opposite end portions of the flat wire extend from the winding portion in the same direction, and the opposite end portions serve as connector connection portions that are to be connected to receiving-side connectors. Such a coil assembly is conductively connected to a circuit board including the receiving-side connector, and is accommodated in an outer case.

### CROSS-REFERENCE TO RELATED APPLICATIONS

This application is the U.S. national stage of PCT/JP2017/029599 filed Aug. 18, 2017, which claims priority of Japanese Patent Application No. JP 2016-162042 filed Aug. 22, 2016.

### TECHNICAL FIELD

The technique disclosed herein relates to a coil assembly, a circuit assembly, and an electrical junction box.

### BACKGROUND

Conventionally, a circuit assembly in which a coil unit including a magnetic core around which a coil formed by a winding a winding wire is disposed is mounted on a circuit board including a conductive circuit, and an electrical junction box in which such a circuit assembly is accommodated in a case are known.

However, the above-described coil unit is relatively large, and is also connected to the circuit board through fastening with bolts. Accordingly, it is necessary to provide a wide region for mounting the coil unit on the circuit board, and the conductive circuit needs to be routed keeping clear of that region. That is, the size of the circuit assembly, and hence the size of the electrical junction box in which the circuit assembly is accommodated are increased.

To perform bolt fastening, it is necessary to draw a circuit-board-side connection portion toward a coil-side connection portion extending from the winding portion of the coil, and to provide a terminal block for holding a nut. Alternatively, it is necessary to bend the coil-side connection portion toward the circuit board side, and to provide a holding portion for holding a nut on the circuit board side, resulting in a complex structure and an increase in the number of components.

The technique disclosed herein has been completed based on the above-described circumstances, and an object thereof is to provide a coil assembly, a circuit assembly, and an electrical junction box that are compact and can reduce the number of components.

### SUMMARY

The technique disclosed herein is directed to a coil assembly including: a magnetic core; and a coil including a winding portion formed by winding a flat wire edgewise, wherein opposite end portions of the flat wire extend from the winding portion in the same direction, and the opposite end portions serve as connector connection portions that are to be connected to receiving-side connectors.

The technique disclosed herein is also directed to a circuit assembly in which the above-described coil assembly is conductively connected to a circuit board including the receiving-side connectors.

Alternatively, the technique disclosed herein is directed to a circuit assembly in which the above-described coil assembly is conductively connected to the circuit board by the receiving-side connectors that are provided separately from the circuit board and that can be connected to the circuit board.

Furthermore, the technique disclosed herein is directed to an electrical junction box obtained by accommodating the above-described circuit assembly in an outer case.

With this configuration, to conductively connect the coil assembly to the circuit board, the connector connection portions on the coil assembly side may simply be fitted to the substrate-side connectors. That is, it is not necessary to perform bolt fastening as in the conventional techniques, and, therefore, there is no need to provide a space for bolt fastening on the circuit board, thus making it possible to make the circuit assembly and the electrical junction box compact.

Since no bolt or nut is necessary, a lower number of components are required, and the configuration for holding a nut becomes unnecessary, thus making it possible to provide a simple overall configuration. In the case of using a heat dissipation plate made of metal in a conventional configuration in which a bolt and a nut are fastened, it is necessary to reliably achieve insulation between the heat dissipation plate and a nut. However, with the above-described configuration in which no nut is used, such a configuration is not necessary, and it is therefore possible to achieve a simpler configuration.

The coil assembly, the circuit assembly, and the electrical junction box described above may have the following configurations.

The magnetic core and the coil may be accommodated in a coil case, a heat dissipating opening may be provided in at least a wall portion of the coil case that intersects an axial direction of the winding portion, and at least a portion of the magnetic core may be exposed from the opening.

With this configuration, it is possible to allow the heat generated in the magnetic core and the coil to escape from the opening. Accordingly, it is possible to obtain a coil assembly, a circuit assembly, and an electrical junction box that have excellent heat dissipation.

The coil case may be formed by a pair of divided bodies that sandwich the magnetic core and the coil from a direction intersecting the axial direction with a gap interposed between the divided bodies.

With this configuration, a relatively large opening can be formed in the coil case with a simple configuration.

A fixing piece for fixing the coil case to a fixed portion may be provided in one piece with the coil case. A fixed portion for fixing the coil assembly may be provided on the outer case.

With this configuration, even when a relatively large coil is about to be displaced from the circuit board due to vibrations of a vehicle or the like, the coil assembly is less likely to be displaced due to the fixing structure of the fixing portion and the fixed portion, thus making it possible to improve the reliability of connection between the coil assembly and the circuit board.

The connector connection portions may each have a flat plate shape.

The above-described circuit assembly may have the following configurations.

The coil assembly may be is connected to the receiving-side connectors, with an extension direction in which the connector connection portions extend from the winding portion being oriented in a direction intersecting the circuit board.

With this configuration, the space required to dispose the coil assembly on the circuit board can be reduced, and it is therefore possible to obtain a circuit assembly and an electrical junction box that are more compact. Since the body portion of the coil assembly is spaced away from the circuit board, it is possible to reduce the influence of noise exerted by the coil on the conductive circuit of the circuit board.

Alternatively, the coil assembly may be connected to the receiving-side connectors, with an extension direction in which the connector connection portions extend from the winding portion being oriented in a direction along the circuit board.

With this configuration, for example, when the circuit board is placed on top of the heat dissipation member, the heat generated from the coil assembly can be promptly conducted by the heat dissipation member, and it is therefore possible to obtain a circuit assembly and an electrical junction box that have excellent heat dissipation.

The outer case may include a fixed-side case to which the circuit board is fixed, and a cover-side case that covers the circuit board that has been fixed to the fixed-side case, and the fixed portion may be provided on the cover-side case.

With this configuration, by fixing the cover-side case to the coil assembly in advance, an electrical junction box can be produced by simply mounting the cover-side case to the fixed-side case.

The cover-side case may be made of metal. The cover-side case may be made of metal. With this configuration, the heat generated by the coil assembly that is fixed to the cover-side case can be more promptly conducted and dissipated to the outside, as compared with a caser in which a a cover-side case made of synthetic resin is used.

The outer case may include a heat dissipation member that is in heat conductive contact with the circuit board, and an accommodating recess that accommodates the coil assembly in a state in which the coil assembly is heat conductive contact therewith may be provided in the heat dissipation member.

With this configuration, the heat generated in the coil assembly can be more efficiently dissipated by the heat dissipation member.

### ADVANTAGEOUS EFFECTS OF INVENTION

According to the technique disclosed herein, it is possible to achieve a coil assembly, a circuit assembly, and an electrical junction box that are compact and can reduce the number of components.

### BRIEF DESCRIPTION OF DRAWINGS

FIG. 1 is a perspective view of a coil assembly according to Embodiment 1.

FIG. 2 is a plan view of the coil assembly.

FIG. 3 is a bottom view of the coil assembly.

FIG. 4 is a front view of the coil assembly.

FIG. 5 is a rear view of the coil assembly.

FIG. 6 is a right side view of the coil assembly.

FIG. 7 is a left side view of the coil assembly.

FIG. 8 is an exploded perspective view of an electrical junction box.

FIG. 9 is a perspective view of the electrical junction box.

FIG. 10 is a plan view of the electrical junction box.

FIG. 11 is a cross-sectional view taken along the line A-A in FIG. 10.

FIG. 12 is an exploded perspective view of a circuit assembly and a heat sink according to Embodiment 2.

FIG. 13 is a perspective view of the circuit assembly and the heat sink.

FIG. 14 is a perspective view of the circuit assembly and the heat sink.

FIG. 15 is a bottom view of a portion of the circuit assembly.

FIG. 16 is a cross-sectional view taken along the line B-B in FIG. 15.

FIG. 17 is an exploded perspective view of a coil assembly and a heat sink according to Embodiment 3.

FIG. 18 is a perspective view of the coil assembly and the heat sink.

FIG. 19 is an exploded perspective view of the circuit assembly.

FIG. 20 is a perspective view of the circuit assembly.

### DETAILED DESCRIPTION OF PREFERRED EMBODIMENTS

### Embodiment 1

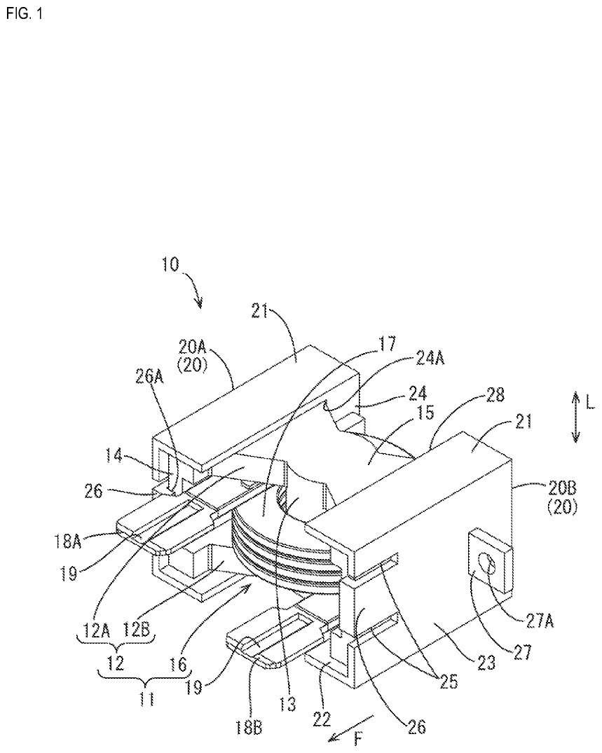

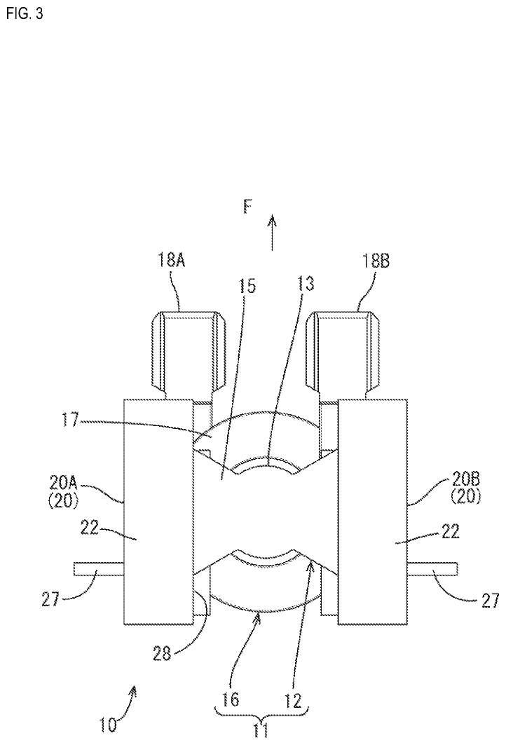

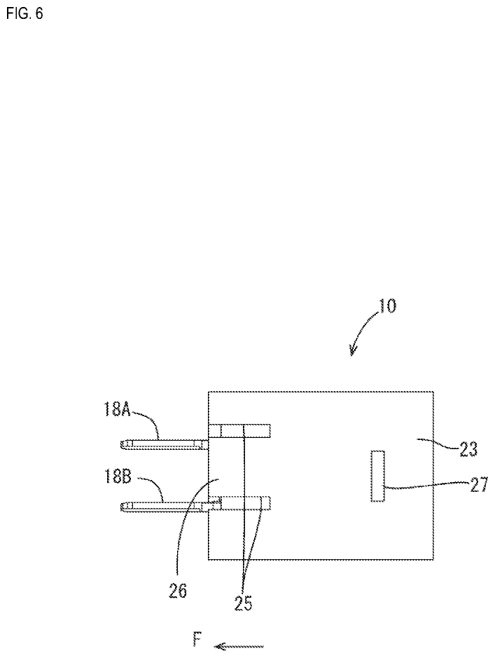

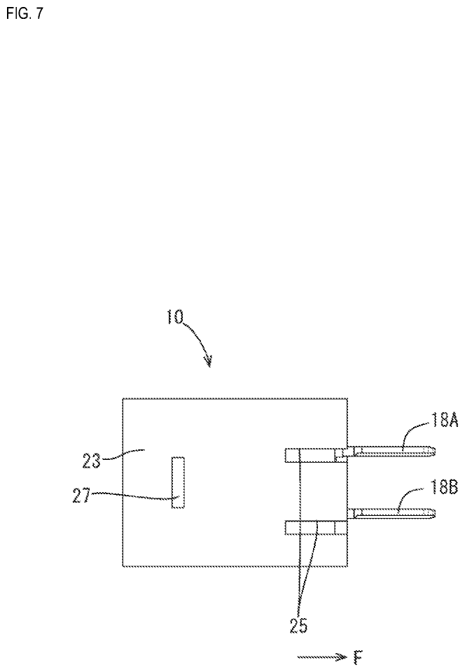

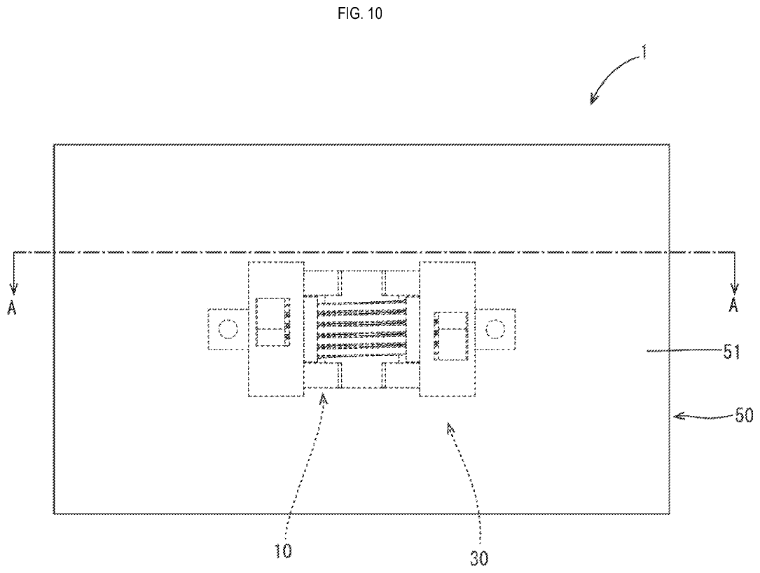

Embodiment 1 will be described with reference to FIGS. 1 to 11.

### Coil Assembly 10

A coil assembly 10 according to the present embodiment is formed by accommodating, in a coil case 20, a magnetic core 12, and a coil 16 formed by winding a winding wire. The following description of the coil assembly 10 is given, assuming that the upper side in FIG. 1 is the upper side, the lower side is the lower side, the left back side is the left side, and the right front side is the right side, the left front side is the front side, and the right back side is the rear side.

The magnetic core 12 is a so-called PQ core, and is formed by combining a pair of a first core 12A and a second core 12B having the same shape. The first core 12A and the second core 12B each include a columnar wound portion 13, a pair of substantially plate-shaped leg portions 14 extending in parallel along the axial direction L of the wound portion 13 on laterally opposite sides, with the wound portion 13 disposed therebetween, and a plate-shaped coupling portion 15 that couples the wound portion 13 and one end portion of each of the pair of leg portions 14 to each other. The wound portion 13 and the leg portions 14 have heights equivalent to the height of the coupling portion 15. Of the side edges of the coupling portion 15, a pair of side edges (the side edges disposed on the front and rear sides) that are not coupled to the leg portions 14 are cut out diagonally from opposite end portions of the leg portions 14 toward the wound portion 13.

The coil 16 is an edgewise coil 16 whose winding wire is made of a flat wire and is wound edgewise. As shown in FIG. 1, the edgewise coil 16 is configured such that opposite end portions of the flat wire extend in a forward direction F (in the same direction, an example of an extension direction), i.e., in a direction substantially orthogonal to the axial direction L of the winding portion 17, from a cylindrically wound winding portion 17, parallel to each other at different heights.

The distal ends of the opposite end portions of the flat wire are formed as a pair of connector connection portions 18A and 18B that are relatively wide and substantially flat. In the upper surface of each of the connector connection portions 18A and 18B, a guide groove 19 for guiding a fitting position to a substrate-side connector 35, which will be described below, is formed extending in the front-rear direction. The connector connection portions 18A and 18B, as a whole, are formed as a flat plate shape that can be connected to substrate-side connectors 35, which will be described below.

The winding portion 17 of the edgewise coil 16 is disposed around the wound portions 13 of the pair of first core 12A and a second core 12B, and thus forms a choke coil 11, together with the magnetic core 12.

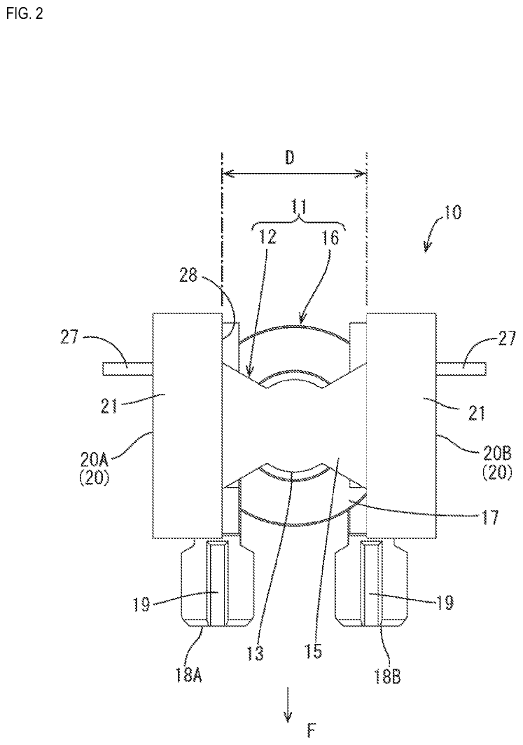

The choke coil 11 is accommodated in the coil case 20. The coil case 20 is made of a synthetic resin material, and is configured such that a portion of each of the front, rear, upper, and lower surfaces thereof is continuously open to the choke coil 11. That is, the coil case 20 is formed by a pair of divided bodies 20A and 20B (see FIG. 2) that sandwich the choke coil 11 from the sides of the pair of leg portions 14 with a distance D therebetween, or in other words, from a direction intersecting the axial direction L of the winding portion 17 and a direction intersecting the extension direction (forward direction F).

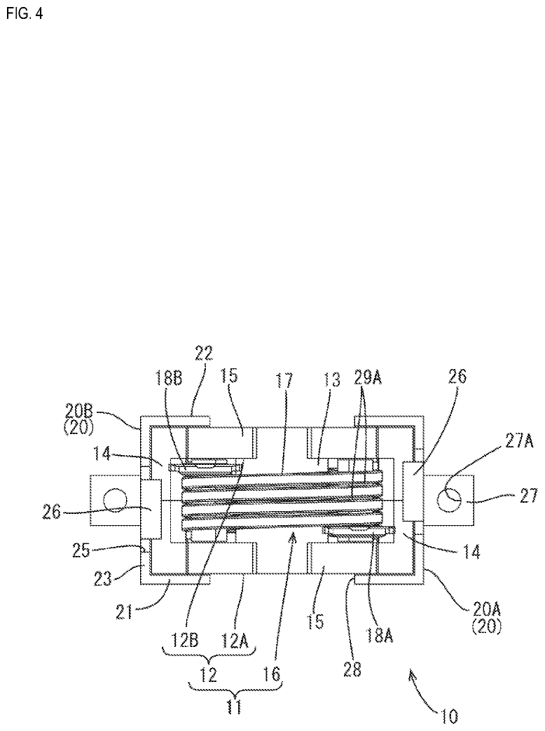

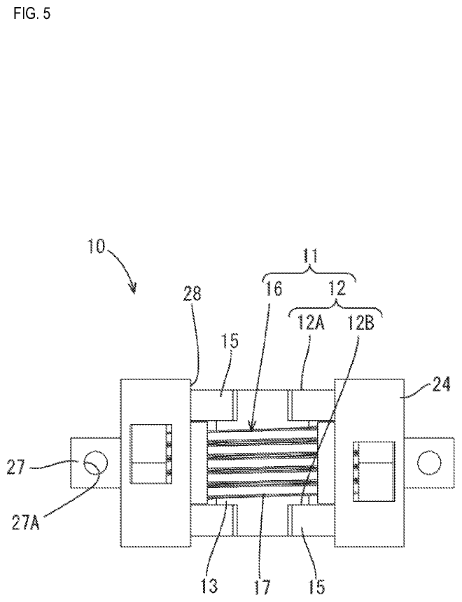

More specifically, the pair of divided bodies 20A and 20B of the coil case 20 are each substantially U-shaped in front view in which a side wall 23 covering the entire corresponding side surface (the corresponding leg portion 14) of the choke coil 11, an upper wall 21 (an example of the wall portion) covering a portion of the upper and lower surfaces of the choke coil 11, and a bottom wall 22 (an example of the wall portion) are coupled together (see FIG. 4). In addition, the upper wall 21 and the bottom wall 22 are coupled to a rear wall 24 (an example of the wall portion) on the rear side thereof (see FIG. 5). The rear wall 24 is coupled to the side wall 23, and has a larger thickness than the other wall portions.

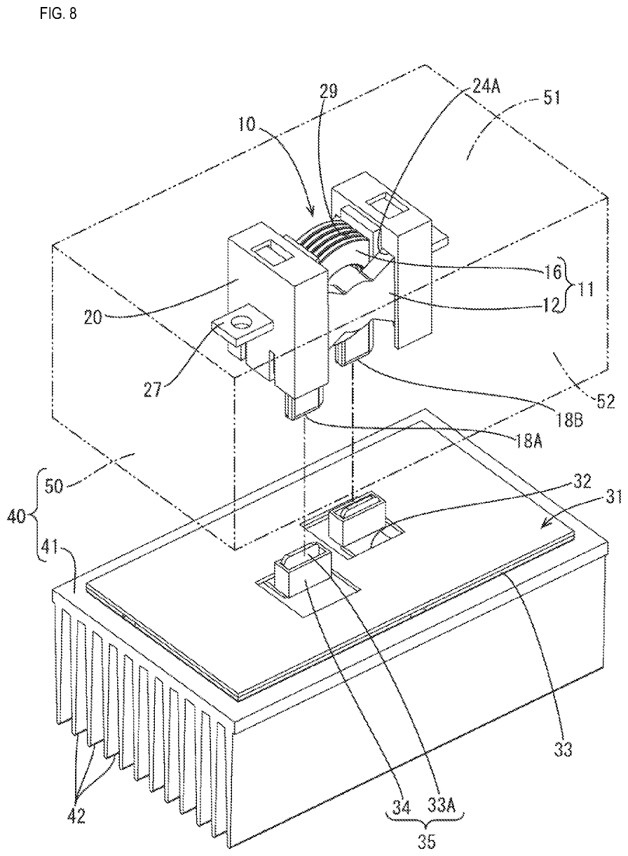

On the inner surface side of the rear wall 24, a receiving recess 24A is provided that is shaped to allow the rear end portion of the choke coil 11 (the rear end portions of the coupling portion 15 of the magnetic core 12 and the winding portion 17 of the coil 16) to be closely fitted thereinside in a state in which the divided bodies 20A and 20B are attached to the choke coil 11 (in a state in which the choke coil 11 is covered by the coil case 20) (see FIGS. 1 and 8).

Portions of the receiving recess 24A that are located in the peripheral region of the region into which the winding portion 17 is fitted protrude in a step form toward the mating divided bodies 20A and 20B, for example, as shown in FIG. 8, thus allowing the winding portion 17 formed in a curved shape to be more deeply fitted thereinside (hereinafter the position into which the winding portion 17 is fitted is referred to as a “coil fitting portion 29”). A plurality of isolation walls 29A that are fitted between adjacent flat wires in the winding portion 17 protrude inward form the inner circumferential surface of the coil fitting portion 29 (see FIG. 4), and the isolation walls 29A allow a flat wire to be held in an isolated state from the adjacent flat wire.

A pair of slits 25 extending rearward are formed in the front end edge of each of the pair of side walls 23, and the region between the slits 25 forms an elastic piece 26 that capable of elastically deforming outward. A locking pawl 26A protruding inward is provided at the front end edge of the elastic piece 26. Accordingly, the divided bodies 20A and 20B are configured such that the rear end portion of the choke coil 11 is fitted into the receiving recess 24A, and the front end edges thereof (the front end edges of the leg portions 14 of the magnetic core 12) are locked by the locking pawls 26A in a state in which the divided bodies 20A and 20B are attached to the choke coil 11 (in a state in which the choke coil 11 is covered by the coil case 20).

Note that the pair of elastic pieces 26 are set to have different heights so as not to interfere with the pair of connector connection portions 18A and 18B of the coil 16 (see FIG. 4).

A plate-shaped fixing piece 27 is provided standing outward on and in one piece with each of the pair of side walls 23 of the coil case 20. Each fixing piece 27 is provided standing perpendicularly from the corresponding side wall 23 such that the plate surface thereof is oriented in the front-rear direction, or in other words, is oriented in the extension direction (the forward direction F) of the connector connection portions 18A and 18B. An attachment hole 27A for attachment to a coil rest 53 (an example of the fixed portion), which will be described below, is formed extending through each of the fixing pieces 27.

### Circuit Assembly 30

As shown in FIG. 8, the circuit assembly 30 may be formed by attaching the coil assembly 10 and electronic components to predetermined positions of a circuit board 31 including a conductive circuit (not shown) formed on the surface of an insulating substrate by printed wiring and a plurality of busbars 33 that are routed and bonded in a predetermined pattern on the back surface. In the present embodiment, only the coil assembly 10 is shown, and the illustration of the other electronic components is omitted.

The circuit board 31 is rectangular, and has connecting through holes 32 formed in portions thereof to which the coil assembly 10 is mounted. Busbars 33 that are exposed from the connecting through holes 32 and are connected to the coil assembly 10 are formed as connection terminals 33A by being bent in an L-shape such that the distal ends thereof protrude to the front side of the circuit board 31. A relay terminal 34 made of metal is attached to each of the connection terminals 33A.

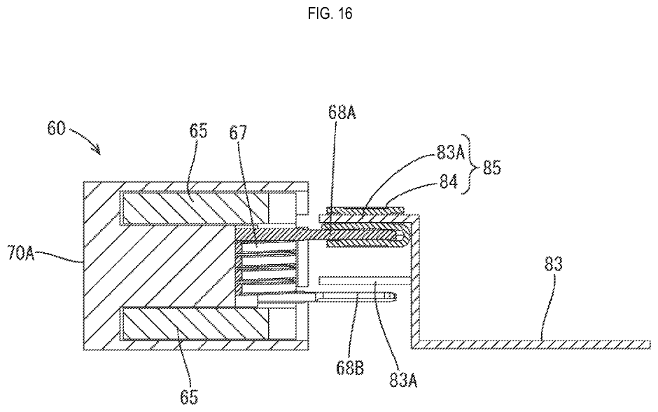

The relay terminal 34 has an overall quadrangular tubular shape, and includes, on the inner side thereof, an elastic contact piece (not shown) formed by folding a tongue piece extending from one side wall thereof (see FIG. 16 of Embodiment 2). In a state in which the relay terminal 34 is attached to the connection terminal 33A of the busbar 33, the relay terminal 34 is conductively connected to the connection terminal 33A by the connection terminal 33A being sandwiched between its tubular outer wall and the elastic contact piece, and forms a substrate-side connector 35 (an example of the receiving-side connector), together with the connection terminal 33A.

When the connector connection portions 18A and 18B of the coil assembly 10 are fitted to the substrate-side connectors 35, guide ribs (not shown) provided on the elastic contact pieces of the relay terminals 34 fit into guide grooves 19 of the connector connection portions 18A and 18B, thereby guiding a fitting position of the coil assembly 10 relative to the substrate-side connectors 35. In a normal fitting state, the elastic contact piece is located between each of the connector connection portions 18A and 18B and the corresponding connection terminal 33A of the busbar 33, thus realizing a conductive connection therebetween. The substrate-side connectors 35 are open toward the upper side in FIG. 8.

### Heat Sink 41

A heat sink 41 (an example of the outer case and the fixed-side case) is disposed on the lower surface side (the surface on the busbar 33 side) of the circuit board 31. The heat sink 41 is a heat dissipation member made of, for example, a metal material having excellent thermal conductivity, such as aluminum or an aluminum alloy, and has the function of dissipating the heat generated in the circuit board 31.

Many plate-shaped fins 42 extending downward are provided on the lower surface of the heat sink 41. Although not shown, an insulation sheet 48 for achieving insulation between the heat sink 41 and the circuit board 31 (the busbars 33) is placed on the upper surface of the heat sink 41. The insulation sheet 48 has adhesiveness capable of being fixed to the busbar 33 and the heat sink 41.

### Cover 50

The upper side of the circuit board 31 is covered by a cover 50 (an example of the outer case and the cover-side case). The cover 50 is made of metal, and is formed in the shape of a box including a rectangular top plate portion 51, and four side walls 52 extending downward from side edge portions of the top plate portion 51.

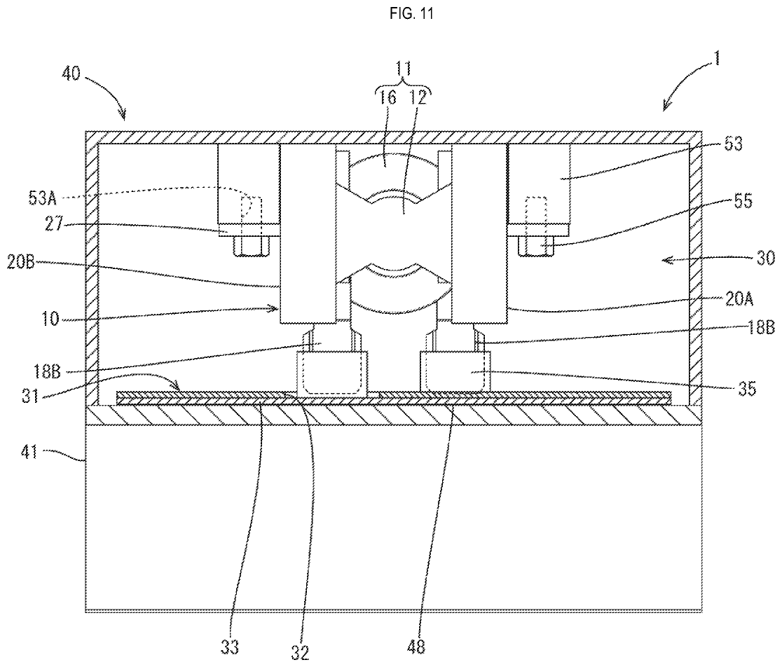

At predetermined positions of the lower surface of the top plate portion 51, coil rests 53 (an example of the fixed portion) are provided at positions corresponding to the fixing pieces 27 of the coil assembly 10 in order to fix the coil assembly 10 to the cover 50 (see FIG. 11). A pair of the coil rests 53 are formed in the shapes of a pair of prisms that extend along the outer sides of the pair of side walls 23 of the coil case 20 when the coil assembly 10 is disposed at a predetermined position, and are set to have height dimensions different from those of the fixing pieces 27. A fixing hole 53A is also formed in each of the coil rests 53 at a position corresponding to the attachment hole 27A of the fixing piece 27 when the fixing piece 27 of the coil assembly 10 is placed on the coil rest 53.

By placing the pair of fixing pieces 27 of the coil assembly 10 on the coil rests 53 and fastening bolts 55, the coil assembly 10 is fixed in one piece with the cover 50 at the predetermined position of the cover 50.

Next, a method for producing a coil assembly 10, a circuit assembly 30, and an electrical junction box 1 will be described.

To produce a coil assembly 10, first, the pair of divided bodies 20A and 20B of the coil case 20 are attached to cover the pair of leg portions 14 of the choke coil 11. The pair of divided bodies 20A and 20B are attached to the choke coil 11 with a gap (distance D) interposed therebetween. Accordingly, the choke coil 11 is brought into a state in which the pair of coupling portions 15 and the lateral opposite end portions of the winding portion 17 are covered by the coil case 20 (the divided bodies 20A and 20B), and the central portions of the upper and lower surfaces and the central portions of the front and rear surfaces are continuously open. Consequently, a portion of the choke coil 11 (the magnetic core 12 and the coil 16) is exposed to the outside. Note that a portion of the coil case 20 that is open is referred to as an opening 28. The opening 28 is used for heat dissipation.

Next, the cover 50 is turned upside down, and the coil assembly 10 is fitted between the pair of coil rests 53 in an orientation in which the pair of fixing pieces 27 of the above-described coil assembly 10 are placed on the pair of coil rests 53 provided on the cover 50. Then, the attachment holes 27A of the pair of fixing pieces 27 of the coil assembly 10 and the fixing holes 53A of the coil rests 53 are aligned with each other, and the bolts 55 are passed therethrough and fastened, thereby attaching the coil assembly 10 to a predetermined position of the cover 50. In this state, the pair of connector connection portions 18A and 18B of the coil assembly 10 protrude toward the side opposite to the top plate portion 51 of the cover 50.

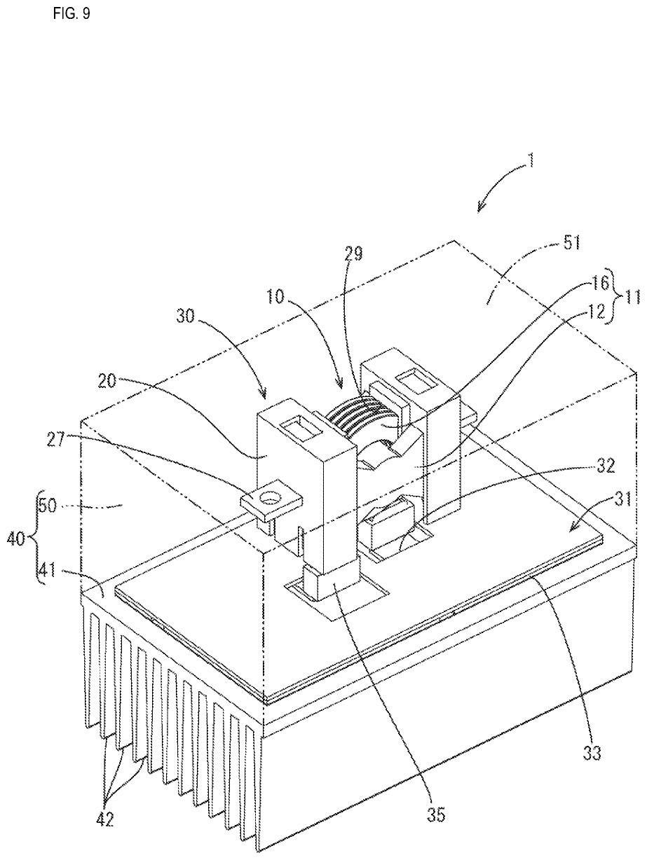

Subsequently, the circuit board 31 is attached to a predetermined position of the heat sink 41, and is covered from above by the cover 50 to which the coil assembly 10 has been fixed, and the cover 50 and the heat sink 41 are fixed to each other with a fixing structure (not shown) (see FIGS. 9 and 11).

At this time, the pair of connector connection portions 18A and 18B that have been fixed to the cover 50 and protrude downward are fitted inside the substrate-side connectors 35 of the circuit board 31 that are open upward. In other words, the coil assembly 10 is connected to the substrate-side connectors 35, with the extension direction F of the pair of connector connection portions 18A and 18B being oriented in a direction intersecting the circuit board 31.

Thus, the coil assembly 10 and the conductive circuit of the circuit board 31 are conductively connected. This completes a circuit assembly 30 in which the connector connection portions 18A and 18B of the coil assembly 10 have been connected to the substrate-side connectors 35 of the circuit board 31, and an electrical junction box 1 in which the circuit assembly 30 is accommodated inside the outer case 40 including the heat sink 41 and the cover 50.

Next, the operations and effects of the present embodiment will be described.

According to the present embodiment, to conductively connect the coil assembly 10 to the circuit board 31, the connector connection portions 18A and 18B on the coil assembly 10 side may simply be fitted to the substrate-side connectors 35. That is, it is not necessary to perform bolt fastening as in the conventional techniques, and, therefore, there is no need to provide a space for bolt fastening on the circuit board 31, thus making it possible to make the circuit assembly 30 and the electrical junction box 1 compact.

Since no bolt or nut is necessary, a lower number of components are required, and the configuration for holding a nut becomes unnecessary, thus making it possible to provide a simple overall configuration. Furthermore, the configuration for reliably achieving insulation between the heat sink 41 and a nut is also not necessary, and it is therefore possible to achieve a simpler configuration as compared with the conventional configurations.

Since the coil case 20 is formed by the pair of divided bodies 20A and 20B, and a relatively large opening 28 is provided by providing the distance D between the two divided bodies 20A and 20B, it is possible to allow the heat generated in the choke coil 11 (the magnetic core 12 and the coil 16) to promptly escape from the opening 28. That is, it is possible to obtain a coil assembly 10, a circuit assembly 30, and an electrical junction box 1 that have excellent heat dissipation.

Moreover, since the cover 50 is made of metal, and is in contact with the coil assembly 10, better heat dissipation can be achieved as compared with that achieved, for example, through the use of a cover made of synthetic resin.

The coil assembly 10 is configured such that the pair of connector connection portions 18A and 18B extend in the same direction from the winding portion 17, and are connected to the substrate-side connectors 35, with the extension direction F being oriented in a direction substantially orthogonal to the circuit board 31. Accordingly, the space required to dispose the coil assembly 10 on the circuit board 31 can be further reduced. That is, it is possible to obtain a circuit assembly 30 and an electrical junction box 1 that are more compact. With this configuration, the choke coil 11 is disposed at a position away from the circuit board 31, and it is therefore possible to reduce the influence of noise exerted by the choke coil 11 on the conductive circuit of the circuit board 31.

Since the cover 50 is provided with the coil rests 35, and the fixing pieces 27 of the coil assembly 10 are fixed to the coil rests 35, the coil assembly 10 becomes less likely to be displaced from the circuit board 31 due to vibrations of a vehicle or the like, and it is therefore possible to more easily improve the reliability of connection between the coil assembly 10 and the circuit board 31.

By fixing the coil assembly 10 to the cover 50 in advance, an electrical junction box 1 can be easily produced by simply mounting the cover 50 to the heat sink 41.

### Embodiment 2

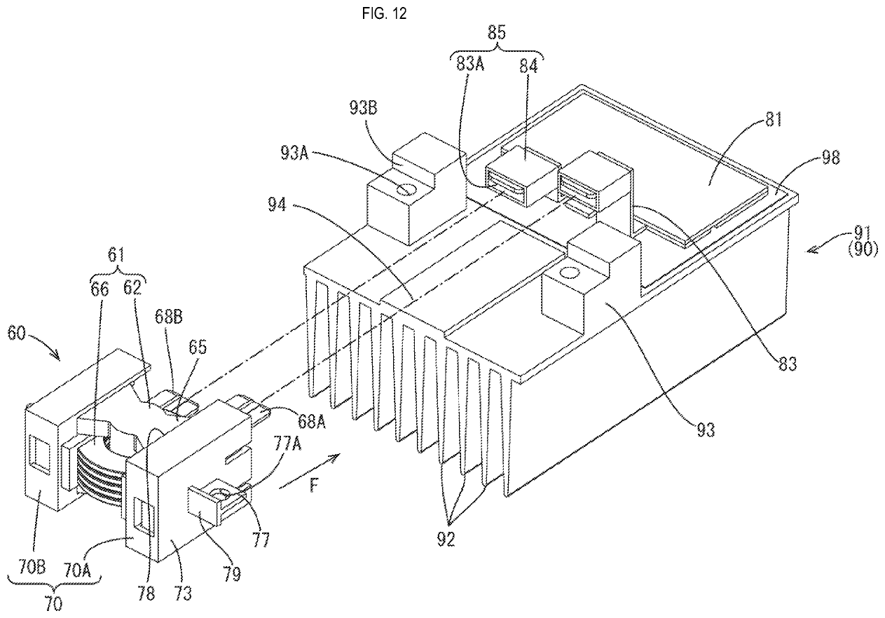

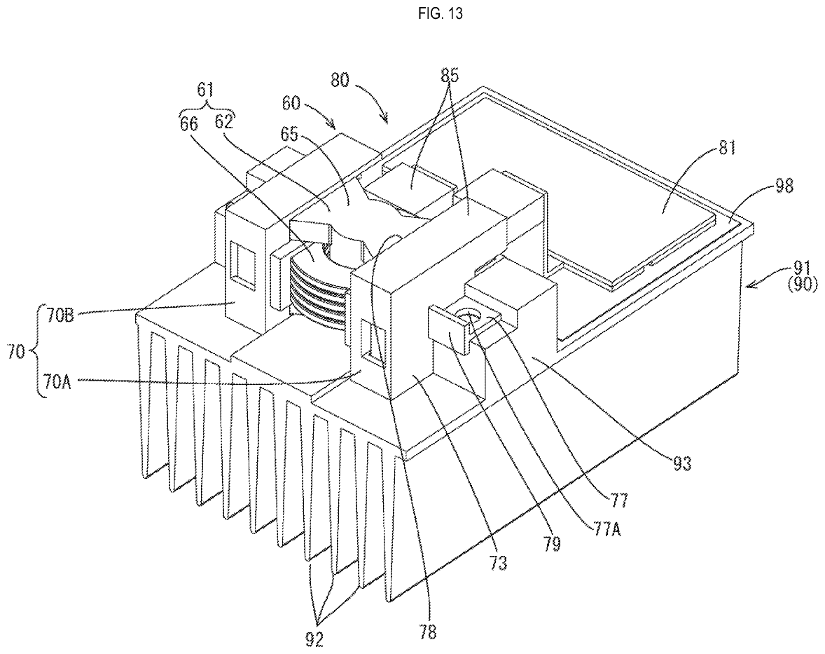

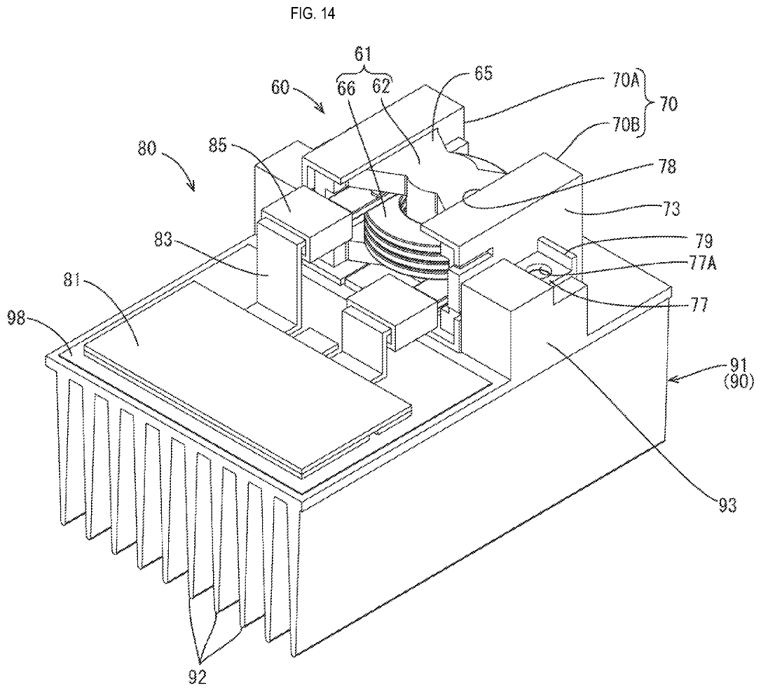

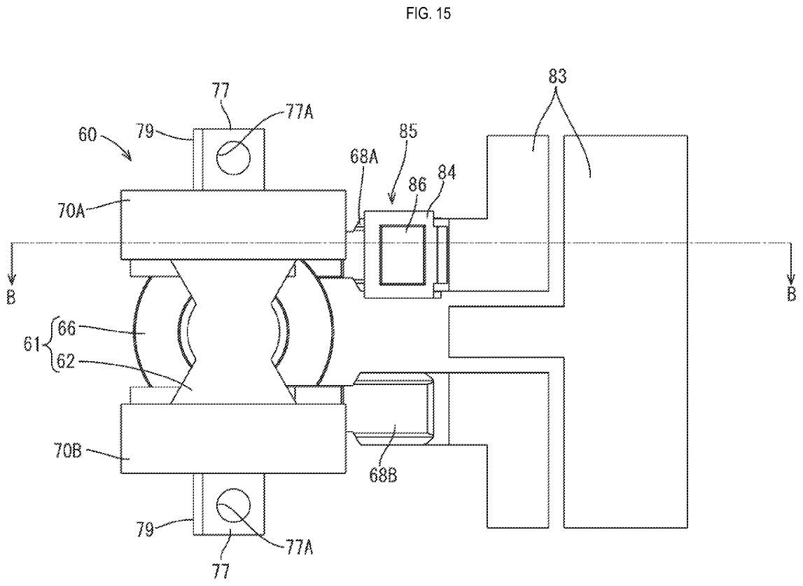

Next, Embodiment 2 will be described with reference to FIGS. 12 to 16. In the following, only the components different from those of Embodiment 1 will be described. The same components as those of Embodiment 1 will be denoted by the same reference numerals but increased by 50, and the redundant description thereof is omitted. Also, the description will be given, assuming that the upper side in FIG. 12 is the upper side and the lower side is the lower side.

A coil assembly 60 according to the present embodiment is different from the coil assembly 10 of Embodiment 1 above with regard to the orientation of fixing pieces 77 provided on a coil case 70. More specifically, each fixing piece 77 is provided standing perpendicularly from the corresponding side wall 73 such that the plate surface thereof is oriented in the up-down direction, or in other words, is oriented in a direction intersecting the extension direction (forward direction F) of a pair of connector connection portions 68A and 68B. A reinforcing portion 79 standing from the corresponding side wall 73 such that the plate surface thereof is oriented in the front-rear direction is provided in one piece with the rear edge portion of each of the pair of fixing pieces 77.

In a circuit board 81 of the present embodiment, of a plurality of busbars 83 routed on the back surface, busbars 83 that are connected to the coil assembly 60 are formed extending outward from one side edge portion of the circuit board 81 and bending upward in a crank shape. Then, the distal end side of each of the busbars 83 serves as a connection terminal 83A, and forms a substrate-side connector 85 (an example of the receiving-side connector), together with a metal relay terminal 84 attached to the connection terminal 83A. The substrate-side connector 85 is open toward a direction along the plate surface of the circuit board 81.

Note that the circuit board 81 of the present embodiment has dimensions for covering about a half of the upper surface of a heat sink 91.

Meanwhile, the heat sink 91 (an example of the outer case and the fixed-side case) is disposed on the lower surface side of the circuit board 81 via an insulation sheet 98. A pair of coil rests 93 (an example of the fixed portion) to which the coil assembly 60 is to be fixed are provided in one piece with the upper surface (the surface on which the circuit board 81 is disposed) of the heat sink 91 at predetermined positions. Each of the coil rests 93 has the shape of a two-level step in which the side on the circuit board 81 is higher, and a fixing hole 93A for fixing the fixing piece 77 is formed in the upper surface on the lower side.

An abutting protrusion 94 for abutting against a magnetic core 62 (coupling portion 65) inserted between a pair of divided bodies 70A and 70B is provided extending in the front-rear direction at a position on the upper surface of the heat sink 91 that corresponds to a coupling portion 65 of the magnetic core 62 that is exposed from the coil case 70 in a state in which the coil assembly 60 is disposed on the heat sink 91. The width dimension of the abutting protrusion 94 is set to be substantially the same as the dimension of a distance D between the pair of divided bodies 70A and 70B.

Such a coil assembly 60 of the present embodiment is connected to the circuit board 81 in the following manner.

First, the coil assembly 60 is brought close to the substrate-side connector 85, with the pair of connector connection portions 68A and 68B of the coil assembly 60 being oriented opposed to openings of the substrate-side connectors 85. At this time, the coil assembly 60 is in a so-called horizontal orientation relative to the circuit board 81.

Then, the abutting protrusion 94 of the heat sink 91 relatively enters between the pair of divided bodies 70A and 70B of the coil assembly 60, as a result of which a fitting position of the coil assembly 60 is guided to a normal position.

As the coil assembly 60 is further brought close to the substrate-side connectors 85, the pair of connector connection portions 68A and 68B of the coil assembly 60 enter into the substrate-side connectors 85 and are fitted thereto, and the fixing pieces 77 are placed on top of the coil rests 93.

At a normal fitting position, the front end edge of each of the fixing pieces 77 abuts against a step portion 93B of the corresponding coil rest 93, and an attachment hole 77A of the fixing piece 77 and the fixing hole 93A of the coil rest 93 coincide with each other. Thereafter, a bolt (not shown) is passed through and is fastened to a nut, thereby fixing the coil assembly 60 to a predetermined position of the heat sink 91. Then, finally, the whole structure is covered by a case from above.

Thus, the conductive circuit between the coil assembly 60 and the circuit board 81 is conductively connected. This completes a circuit assembly 80 in which the connector connection portions 68A and 68B of the coil assembly 60 have been connected to the substrate-side connectors 85 of the circuit board 81, and an electrical junction box in which the circuit assembly 80 is attached to the heat sink 91 and is accommodated in the case.

According to the present embodiment, the coil assembly 60 is connected to the substrate-side connectors 85, with the extension direction F of the pair of connector connection portions 68A and 68B being oriented along the circuit board 81, and the coupling portion 65 of the magnetic core 62 is in contact with the abutting protrusion 94. Accordingly, the heat generated in the coil assembly 60 can be promptly conducted by the heat sink 91. Thus, it is possible to obtain a circuit assembly 80 and an electrical junction box that have excellent heat dissipation.

### Embodiment 3

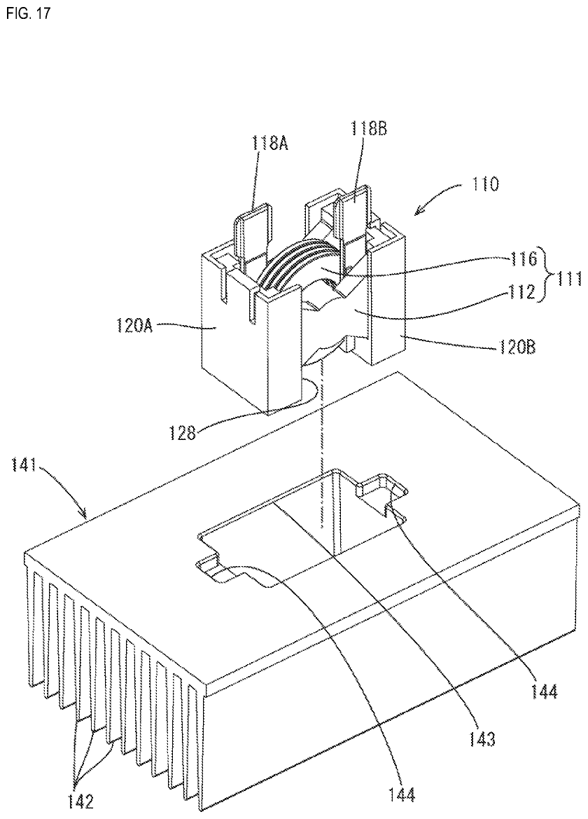

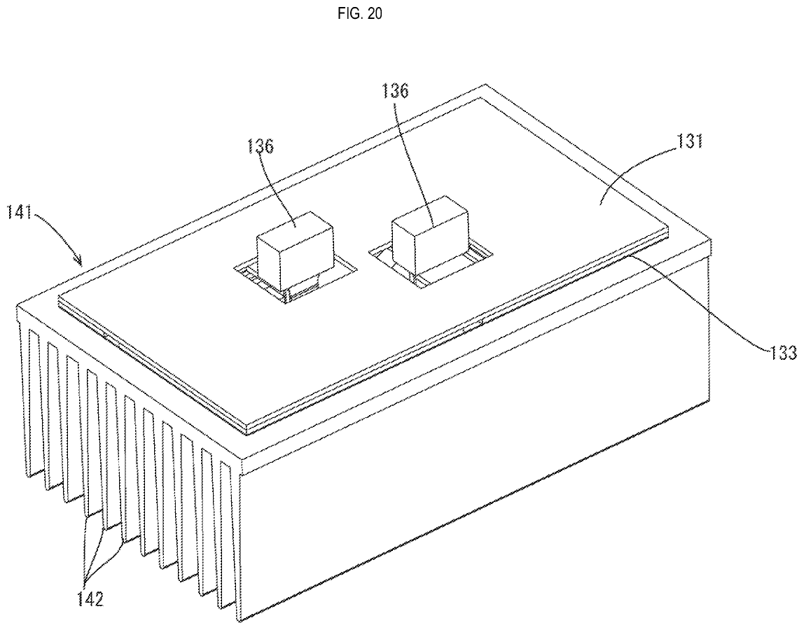

Next, Embodiment 3 will be described with reference to FIGS. 17 to 20.

In the following, only the components different from those of Embodiment 1 will be described. The same components as those of Embodiment 1 will be denoted by the same reference numerals but increased by 100, and the redundant description thereof is omitted. Also, the description will be given, assuming that the upper side in FIG. 17 is the upper side and the lower side is the lower side.

A coil assembly 110 according to the present embodiment is different from the coil assembly 10 of Embodiment 1 above in that no fixing piece is provided on a coil case 120.

In a circuit board 131 according to the present embodiment, busbars 133 that are exposed from connecting through holes 132 and are connected to the coil assembly 110 are formed as connection terminals 133A by the distal end sides thereof being bent upward in an L-shape. However, unlike Embodiment 1 above, no relay terminal is attached thereto.

Meanwhile, an accommodating recess 143 for accommodating the coil assembly 110 is provided at a predetermined position of a heat sink 141. The accommodating recess 143 has a shape that allows the coil assembly 110 to be fitted thereinto in a state in which connector connection portions 118A and 118B protrude outward.

At a pair of opening edge portions of the accommodating recess 143 that are opposed to each other, operation recesses 144 that are cut out outward and are provided continuously with the opening edge portions are provided for allowing fingers or a machine to be fitted in for the operation of placing the coil assembly 110 in an out.

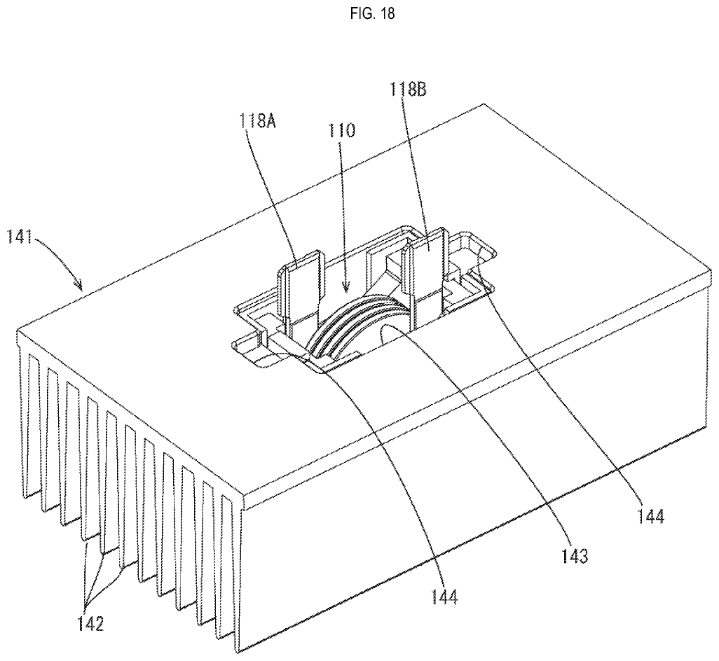

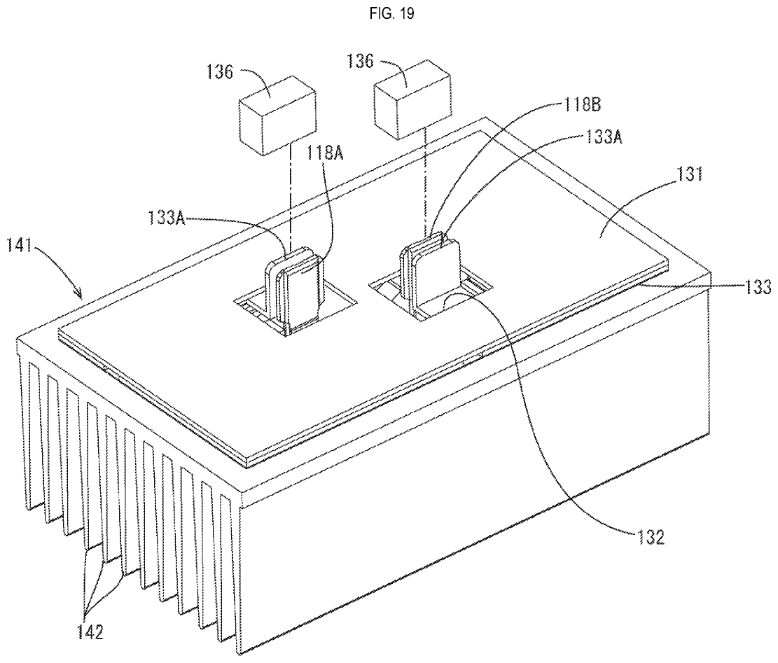

In the present embodiment, first, the coil assembly 110 is accommodated in the accommodating recess 143 of the heat sink 141 in a state in which the pair of connector connection portions 118A and 118B protrude outward (upward) (see FIG. 18), and the circuit board 131 is placed on top of the upper surface of the heat sink 141 (see FIG. 19). Then, the distal end (connection terminal 133A) of each busbar 133 that protrudes upward from the corresponding connecting through hole 132 provided in the circuit board 131, and the connector connection portion 118A or 118B of the coil assembly 110 that also protrudes from the connecting through hole 132 protrude upward from the circuit board 131 in a state in which the plate surfaces thereof are opposed parallel to each other. Then, a relay connector 136 including a relay terminal (not shown) for connecting the two components is fitted and connected to the terminals (133A and 118A, or 118B), and, thereby, a circuit board 131 to which the coil assembly 110 has been connected can be obtained.

According to the present embodiment, the heat generated in the coil assembly 110 can be more efficiently dissipated by the heat sink 141.

### OTHER EMBODIMENTS

The technique described herein is not limited to the embodiments described and illustrated above. For example, the following embodiments are also included in the technical scope thereof.

In the above embodiments, the connector connection portions of the coil assembly are connected to the substrate-side connectors on the circuit board;

however, the mating connectors (the receiving-side connectors) are not limited to the above embodiments. For example, the connector connection portions may be connected to connectors provided outside of the electrical junction box.

In the above embodiments, the coil case is formed by a pair of divided bodies, and a relatively large opening is formed; however, the coil case is not limited to the above embodiments. For example, a relatively small opening may be provided in a side surface of a box-shaped coil case whose one surface serves as an insertion opening for inserting a coil. Alternatively, it is possible to adopt a configuration in which no heat dissipating opening is provided.

In the above embodiments, both of the magnetic core 12 and the coil 16 are exposed from the opening 28 of the coil case 20; however, one of the magnetic core 12 and the coil 16 may be exposed.

In the above embodiments, the fixing pieces for fixing the coil assembly to the fixed portions are provided on the coil case; however, the fixing pieces may be omitted.

In the above embodiments, the coil rests are provided on the outer case as the fixed portions for fixing the coil assembly; however, the fixed portions are not limited to the above embodiments. For example, a fitting recess into which the coil assembly is fitted may be provided on the outer case.

In the above embodiments, the coil assembly is connected to the connectors provided on the circuit board; however, the coil assembly may be connected to connectors other than the connectors provided on the circuit board.

In the above embodiments 1, the cover 50 is made of metal; however, the cover 50 may be made of synthetic resin.

In the above embodiments, the connector connection portions 18A and 18B of the coil 16 each include the guide groove 19; however, flat plate-shaped connector connection portions including no guide groove 19 are also included within the technical scope of the present invention.

1. A coil assembly comprising:
a magnetic core; and a coil including a winding portion formed by winding a flat wire edgewise,
wherein opposite end portions of the flat wire extend from the winding portion in the same direction, and the opposite end portions serve as connector connection portions that are to be connected to receiving-side connectors.

2. The coil assembly according to claim 1,
wherein the magnetic core and the coil are accommodated in a coil case, a heat dissipating opening is provided in at least a wall portion of the coil case that intersects an axial direction of the winding portion, and at least a portion of the magnetic core is exposed from the opening.

3. The coil assembly according to claim 2,
wherein the coil case is formed by a pair of divided bodies that sandwich the magnetic core and the coil from a direction intersecting the axial direction with a gap interposed between the divided bodies.

4. The coil assembly according to claim 2,
wherein a fixing piece for fixing the coil case to a fixed portion is provided in one piece with the coil case.

5. The coil assembly according to claim 1,
wherein the connector connection portions each have a flat plate shape.

6. A circuit assembly in which
the coil assembly according to claim 1 is conductively connected to a circuit board including the receiving-side connectors.

7. A circuit assembly in which
the coil assembly according to claim 1 is conductively connected to the circuit board by the receiving-side connectors that are provided separately from the circuit board and that can be connected to the circuit board.

8. The circuit assembly according to claim 6,
wherein the coil assembly is connected to the receiving-side connectors, with an extension direction in which the connector connection portions extend from the winding portion being oriented in a direction intersecting the circuit board.

9. The circuit assembly according to claim 6,
wherein the coil assembly is connected to the receiving-side connectors, with an extension direction in which the connector connection portions extend from the winding portion being oriented in a direction along the circuit board.

10. An electrical junction box obtained by
accommodating the circuit assembly according to claim 1 in an outer case.

11. The electrical junction box according to claim 10,
wherein a fixed portion for fixing the coil assembly is provided on the outer case.

12. The electrical junction box according to claim 11,
wherein the outer case includes a fixed-side case to which the circuit board is fixed, and a cover-side case that covers the circuit board that has been fixed to the fixed-side case, and
the fixed portion is provided on the cover-side case.

13. The electrical junction box according to claim 11,
wherein the cover-side case is made of metal.

14. The electrical junction box according to claim 10,
wherein the outer case includes a heat dissipation member that is in heat conductive contact with the circuit board, and an accommodating recess that accommodates the coil assembly in a state in which the coil assembly is heat conductive contact therewith is provided in the heat dissipation member.
